(19) United States
(12) Patent Application Publication
(10) Pub. No.: US 2007/0282924 A1
(43) Pub. Date: Dec. 6, 2007

(54) DEVICES AND METHODS FOR CHECKING AND DETERMINING CONTROL VALUES

(76) Inventors: Stefan Kraegeloh, Erlangen (DE); Joerg Pickel, Pommelsbrunn (DE); Ralph Kulessa, Hilpolstein (DE); Patrick Aichroth, Ilmenau (DE); Kurt Michael Krauss, Nuernberg (DE); Jens Hasselbach, Erlangen (DE); Stefan Puchta, Langewiesen (DE); Marc Gayer, Erlangen (DE); Harald Popp, Tuchenbach (DE)

Correspondence Address: GLENN PATENT GROUP, 3475 EDISON WAY, SUITE L, MENLO PARK, CA, 94025, US

(21) Appl. No.: 11/735,288

(22) Filed: Apr. 13, 2007

Related U.S. Application Data
(63) Continuation of application No. PCT/EP2005/009783, filed on Sep. 12, 2005.

(30) Foreign Application Priority Data
Oct. 15, 2004 (DE) 102004051771.1

(51) Int. Cl. G06F 17/30

(52) U.S. Cl. 707/203; 707/E17.007

(57) ABSTRACT

A device for checking a data set, wherein the data set has a plurality of partial sets and a partial control value per partial set includes a determiner for determining a control value and comparer. The determiner for determining a control value is formed so as to determine a common control value from the partial control values of the partial sets. The comparer is formed so as to compare the common control value to a comparison value provided to the comparer.

### CROSS-REFERENCE TO RELATED APPLICATIONS

This application is a continuation of copending International Application No. PCT/EP2005/009783, filed Sep. 12, 2005, which designated the United States, and was not published in English and is incorporated herein by reference in its entirety.

### TECHNICAL FIELD

This invention refers to a device and a method for checking a data set by means of control values and a device and a method for determining a comparison control value for a data set, which can be e.g. a computer file.

### BACKGROUND

For most diverse applications, e.g. in Digital Rights Management, it is desired or necessary to check the authenticity or the integrity of a file or a bit stream before using it. As regards the checking of a data set as to its integrity, this can be e.g. areas to be checked in the RAM or ROM of a computer or a file on a bulk storage. During checking, manipulations of the data can be discovered or memories or writing errors can be identified before the data are further processed.

In particular for audio applications or video applications the data set is very large, even when the data are present in compressed form. For example, a typical MP3-coded song generates a data set of 1 MB per minute of play time.

In order to check the integrity of a file e.g. by means of a hash algorithm, the hash algorithm is usually calculated on the complete file and the result, thus the hash value, is then compared to a reference value.

Hereafter is described such a checking of the integrity of a data set by means of a cryptographic hash method. Cryptographic hash values are also called checksum. Hash methods calculate from an input value of an undetermined length, in a defined and unique way, a determined output value, the so-called hash. The hash value is e.g. a 20-byte character string. The individual character of the hash function is to determine for each arbitrary input value a unique associated output value, from which the input value cannot be backward calculated.

The complete data set on which the hash value is to be calculated is first processed with the hash algorithm, so as to form the hash of the data set. For the subsequent checking of the integrity the data set to be tested is again processed completely with the hash algorithm. If the data set to be tested provides the same hash as during the reference run, it may be assumed that no changes were made to the data set.

The main object of hash functions is to check and guarantee the integrity of digital data. Applications reach from calculations of checksums to signature methods. That is, the hash is used either directly as a checksum or in addition also signed as representing the original data set. For checking the integrity the hash value is directly used as a checksum.

The requirements for hash functions can substantially be centred on the following three points. On the one hand, each hash value should occur with the same frequency. This means that the probability of hash values may not differ for different input values. Furthermore, small changes of the input value should lead to a different hash value. Furthermore, the efforts for generating collisions should be very high. This means that it should be as difficult as possible, for a given input value, to find a second input value with the same hash value. A hash function meeting the three requirements mentioned is called cryptographic hash function.

Among the most important cryptographic hash functions are SHA-1, MD4, MD5 as well as RIPE-MD-160. The currently most important cryptographic hash function SHA-1 (SHA; SHA=Secure Hash Algorithm) processes blocks of a 512-bit length and generates hash values of a 160-bit length. For SHA-1, five 32-bit variables, so-called chain variables, as well as the so-called compression function play an important role.

For the hash function SHA-1, the input value is first of all divided into blocks of a 512-bit length. Then, the compression function takes the five chain variables as well as a 512-bit block and reproduces them on the next five 32-bit values. The function is then performed in four runs of 20 identical operations each, where the individual bits are shifted after predefined arithmetic operations. Finally, the contents of the five chain variables are output as hash value.

A use of hash methods for checking the integrity is described e.g. in the specification “Open Mobil Alliance; OMA DRM Specification V2.0; Draft version 2.0—10 Apr. 2004”. Further checking methods are described e.g. in the specification “Internet Streaming Media Alliance, Encryption and Authentication Specification, version 1.0, February, 2004”.

Usually, the checking of the integrity of a data set is no purpose in itself. To the contrary, the checking of the integrity is performed only before actually using the data set. Therefore, the efforts for checking the integrity are a disadvantage when using a data set, since the checking of the integrity is associated with an additional complexity, which causes additional costs and delays in the use of the data set.

In particular, the high cost of time for checking the integrity and the use of resources required, in particular the arithmetic performance for carrying out of the calculation of the checksum is an important disadvantage. The high efforts required are particularly important, since the whole data set must always be checked first, before a statement can be made on whether the integrity of the data set exists. This has an influence in particular in the case of very large data sets and can cause, e.g. in the case of audio and video files, starting delays when playing audio data or video data.

A further substantial disadvantage resides in the high energy-consumption, which results from the necessity to always first check the whole data set. This is also necessary when perhaps only part of the data is to be used. Thus, e.g., in the case of playing a short segment or forward winding or rewinding of a DRM-protected audio work or video work on a portable player, it is also necessary to perform first a checking of the whole audio work or video work. In particular, in the case of portable apparatus, this entails a reduction of the battery life.

Another disadvantage resides in that no statement about a data set is possible as long as only part of the data is present. This is a disadvantage, since, in the case of a negative result of the test, the actual treatment can or should in most cases be omitted.

Another disadvantage is that a partial use of the data requires the same checking effort as a complete use of the data. Starting delays also occur when only short segments of audio/video works are played or when forward winding or rewinding should occur within a work.

### SUMMARY

According to an embodiment, a device for checking a data set, the data set having a plurality of partial sets and a partial control value per partial set, may have: a determiner for determining a control value, which is formed so as to determine a common control value from the provided partial control values of the partial sets of the data set; a comparer, which is formed so as to compare the common control value to a comparison control value provided to the comparer; wherein the determiner is formed, furthermore, so as to determine a further partial control value for one of the partial sets of the data set; and wherein the comparer is formed, furthermore, so as to compare, for checking the partial set, the further partial control value to the provided partial control value of the corresponding partial set and to provide a check result as a function of the comparison; and a user for using the data set, which is formed so as to use the data of one of the partial sets in parallel to the checking of the partial set, and is formed, furthermore, so as to interrupt a use of the data set as a consequence of the check result, when the check result indicates a mismatch.

According to another embodiment, a method for checking a data set, wherein the data set has a plurality of partial sets and a partial control value per partial set, may have the steps of: determining a common control value from the provided partial control values of the partial sets; comparing the common control value to a provided comparison control value; determining a further partial control value for one of the partial sets of the data set; comparing the further partial control value to the provided partial control value of the corresponding partial set for checking the partial set and providing a check result as a function of the comparison; using the data of one of the partial sets in parallel to the checking of the partial set; and interrupting a use of the partial set as a consequence of the check result, when the check result indicates a mismatch.

According to another embodiment, a computer program with a program code for performing the method for checking a data set, wherein the data set has a plurality of partial sets and a partial control value per partial set, wherein the method may have the steps of: determining a common control value from the provided partial control values of the partial sets; comparing the common control value to a provided comparison control value; determining a further partial control value for one of the partial sets of the data set; comparing the further partial control value to the provided partial control value of the corresponding partial set for checking the partial set and providing a check result as a function of the comparison; using the data of one of the partial sets in parallel to the checking of the partial set; and interrupting a use of the partial set as a consequence of the check result, when the check result indicates a mismatch; when the computer program is executed on a computer.

This invention is based on the knowledge that a checking per section or partial checking of the integrity of a data set results into a reduction of complexity required for checking the integrity or for forming the control value.

According to the approach of the invention, no control value is formed on the entire data set, but control values are formed on partial sets of the data set. The control values for these partial sets are stored either in the data set or separately. Furthermore, an additional control value is formed on the partial control values. This is advantageous, since, for checking the integrity of the data set, the partial control values can first be checked against the additional control values. Subsequently, the individual partial areas can be checked by means of the checksums associated with the individual partial areas.

A series of advantages result from the possibility of checking the integrity according to the approach of the invention per section. In particular, the use of data is already possible when only the first section of the data set and not yet the entire data set has been checked. For example, playing an audio/video work can thus start almost without any time delay. Furthermore, a data set can alternatively also be used only partially, without the entire data set having to be checked. For example, in the case of fast forward winding and rewinding within an audio/video work or of a jump within the work, a checking per section is advantageous. Thanks to the checking per section, the checking of sections not required is omitted. Thus, time and resources are saved.

According to a further exemplary embodiment, the actual use of the data can occur in sections in parallel to the checking of the integrity. Therefore, a data section must be loaded e.g. only once from a disc, in order to then check the integrity of the section and to then process it immediately. This results into time, resources and energy savings.

According to a further exemplary embodiment, the checking can also be postponed. This is possible when it is acceptable for individual works of the file to be used without checking. For example the first work or a further work of a music file is used and the use is checked in parallel thereto. This has the advantage that the data to be checked are checked during the execution. Furthermore, the data to be used must be retrieved only once from the hard disk. If the checking is successful, the next work is released for processing. Otherwise, the processing stops after the work that has just been executed.

Furthermore, the approach according to invention enables a fast pre-checking of a data set by pre-checking the control values of the partial sections of a data set. In this way can take place e.g. a fast overview of a large number of data sets. The actual checking of the data sets themselves by means of the control values then occurs only after the checking of the control values.

According to a further exemplary embodiment, further intermediate control values can be formed from the partial control values of the individual partial sets. From the intermediate control values the number of which is smaller than the number of partial control values is formed, in turn, a common control value. This has the advantage that a fast pre-checking can take place for a large number of partial sets by comparing the common control value to a control value determined from the intermediate control values. Only then the partial control values are checked against the corresponding intermediate control values. The determination of the common control value from the intermediate control values is associated with substantially less complexity then when a common control value must be calculated from the partial control values.

The approach of the invention can advantageously be used in connection with the DCF format (DCF; DCF=DRM Content Format). The DCF format is described in “Open Mobile Alliance; DRM Content Format V2.0; Draft version 2.0—20 April, 2004” and is used for encrypted audio/video data in MPEG-4 data format.

### BRIEF DESCRIPTION OF THE DRAWINGS

Embodiments of the present invention will be detailed subsequently referring to the appended drawings, in which

FIG. 1 shows a block diagram of a device for checking a data set according to an exemplary embodiment of this invention; and

FIG. 2 shows a block diagram of a device for determining a control value according to a further exemplary embodiment of this invention.

### DETAILED DESCRIPTION

In the following description of the preferred exemplary embodiments of this invention, identical or similar reference numerals are used for similar elements shown in the various drawings, a repeated description of these elements being omitted.

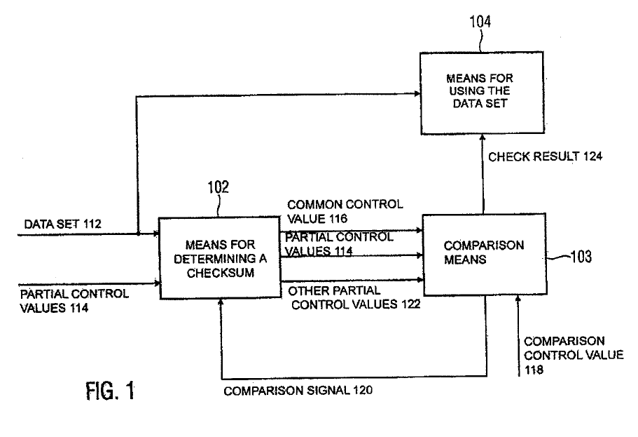

FIG. 1 shows a schematic representation of a device to checking a data set including means 102 for determining a control value, comparison means 103 and means 104 for using the data set. The device for checking a data set is formed so as to check the data set before a use by means of partial control values and a comparison control value. The partial control values and the comparison control value are provided together with the data set to the device for checking a data set.

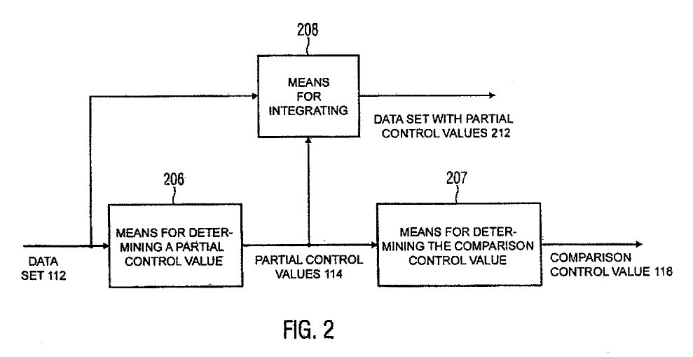

The means 102 for determining a control value is formed so as to receive a data set 112. The data set 112 is subdivided into a plurality of partial sets (not shown in the figures). A partial control value 114 was calculated for each of the partial sets of the data set 112. The partial control values 114 are also provided to the means 102 for determining a control value. Furthermore, from the partial control values 114 was formed a comparison control value 118, which is also provided to the device for checking a data set. The partial control values 114 as well as the comparison control value 118 were e.g. temporarily stored in the device for determining a control value from the data set shown in FIG. 2, together with the data set.

The means 102 for determining a control value is formed so as to calculate a common control value 116 from the partial control values 114 and to provide same to the comparison means 103. Furthermore, the comparison means 103 is formed so as to receive a comparison control value 118. The comparison control value 118 was also formed from the partial control values 114. The same calculation function was used for forming the comparison control value 118 as well as the common control value 116. The comparison means 103 is formed so as to compare the common control value 116 to the comparison control value 118. According to this exemplary embodiment, the comparison means 103 is formed so as to provide a comparison signal 120 to the means 102 for determining a control value, as a function of the result of comparison between the common control value 116 and the comparison control value 118. The comparison signal 120 indicates whether the comparison control value 118 matches the common control value 116. In the case of a match between the common control value 116 and the comparison control value 118, it can be assumed that the partial control values 114 from which the common control value 116 was formed was not changed since the comparison control value 118 was formed.

According to this exemplary embodiment, the means 102 for determining a control value is formed so as to calculate, in the event of a comparison signal 120 indicating a match of the comparison control value to 118 and the common control value 116, a first further partial control value 122 from a first partial set of the data set 112, and to provide same to the comparison means 103. The comparison means 103 is also formed so as to receive the partial control values 114. Reacting to receiving a further partial control value 122, the comparison means 103 is formed so as to compare the further partial control value 122 to the corresponding partial control value 114 formed from the same partial set as the further partial control value 122. Depending on the comparison of the partial control value 114 to the further partial control value 122, the comparison means 103 is formed so as to provide a check result 124 to the means for using the data set. The check result 124 indicates whether the partial control value 114 matches or not the corresponding further partial control value 122. The further partial control value 122 was formed from the corresponding partial set according to the same algorithm as the partial control value 114. Thus, in the event of a match between the partial control value 114 and the further partial control value 122, it can be assumed that the partial data set from which the further partial control value 122 was calculated was not changed since the calculation of the corresponding partial control value 114.

The means 104 for using the data set is formed so as to use, in the event of a check result 124 indicating a match between the partial control value 114 and the further partial control value 122, the partial set of the data set 112 for which the further partial control value 122 was formed and compared in the comparison means 103.

Alternatively, the means 102 for determining a control value can be formed so as to determine in parallel, as a consequence of the comparison signal 120, the further partial control values 122 of the partial set of the data set 112 and to provide same to the comparison means 103. Furthermore, the means for determining a control value 102 can be formed so as to already form the further partial control values 122 before the common control value 116 was compared to the comparison control values 118.

The partial control values 114 can be provided separately from the data set 112 to the means 102 for determining a control value. Alternatively, the partial control values can be integrated 114 into the data set 112. Likewise, the comparison control value 118 can be provided together with the data set 112 to the device for checking a data set.

If the partial control values 114 are provided to the device for checking a data set only after a partial set of the data set 112 was provided to the means 102 for determining a control value, the means 102 as determining a control value can be formed so as to already form the further partial control values 122 of the partial sets already received. In this case, the common control value 116 is determined only when the partial control values 114 have been received from the means 102 for determining a control value.

The means 104 for using the data set can be formed so as to already use the data set 112 or partial sets of the data set 112 before a check result 124 was received. In this case, the means 104 for using the data set can be formed so as to interrupt a use of the data set when a check result 124 is received, which indicates a mismatch between a partial control value 114 and a further partial control value 122 or a mismatch between the common control value 116 and the comparison control value 118.

FIG. 2 shows a schematic representation of a device for determining a control value according to an exemplary embodiment of this invention.

In particular, the device for determining a control value is formed so as to provide partial control values 114 and a comparison control value available 118 that can be used by the device for checking a data set shown in FIG. 1, in order to check an integrity of the data set.

The device for determining a control value includes means 206 for determining a partial control value, means 207 for determining the comparison control value and means 208 for integrating. The device for determining a control value is formed so as to receive a data set 112. The data set 112 includes a plurality of partial sets. The means 206 for determining a partial control value is formed so as to form from the partial sets of the data set received 112 partial control values 114 and to provide same to the means 207 for determining the comparison control value. For each partial set of the data set 112 a partial control value 114 is thus provided to the means 207 for determining the comparison control value. The partial control values 114 are determined by the means 206 for determining a partial control value from the partial sets according to a predetermined determination algorithm.

When the data set 112 is not divided into partial sets, the means 206 for determining a partial control value can include means for subdividing the data set (not shown in the figures) into the plurality of partial sets.

The means 207 for determining the comparison control value is formed so as to determine the comparison control value 118 from the partial control values 114 according to a predetermined determination rule and to provide same.

Both the partial control values 114 and the comparison control value 118 are stored or made available for subsequent treatment. According to this exemplary embodiment, the partial control values 114 are provided to the means 208 for integrating. The means 208 for integrating is formed so as to receive the data set 112, to integrate the data set available 112 into the data set 112 and to provide same as a data set 212 with partial control values.

According to an exemplary embodiment, the partial control values 114 are integrated into the data set 112 by the means 208 for integrating so that they are arranged if possible according to a uniform distribution in the data set 212. Alternatively, the partial control values 114 can be arranged together in the data set 212 at a predetermined location.

When the partial control values 114 are scattered over the data set 212, it is possible, by checking the partial control values, to already determine with high probability whether errors occurred during storage or transmission of the data set 212. Storing the partial control values 114 at a fixed location of the data set 212 has the advantage that, during a subsequent checking of the data set 212, the partial control values can be read first and can be compared to the comparison control value 118.

Alternatively, the partial control values 114 can be stored separately from the data set 112. Likewise, the comparison control value 118 can be integrated into the data set 112 or also stored separately.

According to an exemplary embodiment, the control values are determined by means of cryptographic hash functions. According to this exemplary embodiment, a checking per section of the integrity of large files, for example a song, occurs in MP3-format by means of a hash algorithm, a hash value or a checking “on the fly”. The data are divided into sections, e.g. chunks or access units, in the case of MPEG-4-coded audio data, which correspond to the partial sets.

Hashing in the device for determining a control value occurs through separately hashing the individual sections. Subsequently, the hash values determined from the sections are stored in a table, which is e.g. stored together with the data. A new hash is formed on this table of hash values and used as actual hash, the so-called master hash. The hash values correspond to the partial control values and the master hash to the comparison control value.

Dividing into sections is performed into sections of a suitable or desired size. A compromise is formed between granularity and additionally required memory space for the additional hash values. After hashing the sections, the hash values of the sections are stored in one or more tables. Then occurs the formation of a hash value on the table or the tables with the partial hash values. The master hash can then be stored externally and is the reference against which the checking should occur subsequently.

For checking the hash in the device for checking a data set, a pre-checking of the table of the hashes with the master hash is performed first, i.e. a hash is calculated on the table or the tables with the partial hash values and compared to the master hash. Subsequently, a checking of the individual sections is performed using the hash values from the table. To this end, the partial hash values from the table are used to individually check the sections of the file. The checking of the partial sections thus occurs, in this exemplary embodiment, when there exists a match between the master hash and the hash that has been calculated on the partial hash values. In this way, sections already checked can already be used, while others have not yet been checked.

According to another exemplary embodiment, so many sections are formed that a table with partial hash values becomes too large. In this case, several hash tables can be used hierarchically. This means that the first table contains hash values that are used, in turn, as master hashes for subordinated tables. As a special case, a sequential list can be established. This means that the last hash value in a table is the master hash for the next table, etc.

According to another exemplary embodiment is described the hash table and the master hash for objects encrypted according to DCF (DCF; DCF=DRM Content Format), which most often contain coded audio/video data in MPEG-4 data format. The DCF object is subdivided into a desired number of sections, the so-called chunks, one or more access units being each time grouped. A chunk table with this information is inserted into the DCF object. A hash is each time calculated on the chunks with the hash algorithm SHA-1. A table is formed from all calculated hashes and this table is inserted as Mpeg-4 atom into the DCF object. The master hash is formed on the table of the hash values, which is stored externally to the DCF object as reference value.

A checking of the integrity is performed by reading the Mpeg-4 atom with the table of the hash values from the DCF object. Subsequently, hash values are calculated on the table and compared to the master hash. In the event of a match, the use of the DCF object can be continued, otherwise the DCF object is rejected as being changed. If the use of the DCF object is continued, the desired chunk is then looked for in the DCF object and a processing of this chunk then occurs, e.g. its reproduction with a simultaneous checking of the hashes in this chunk. The simultaneous checking of the hashes of the corresponding chunks is called checking “on the fly”. If the hash value of the chunk matches the corresponding value from the hash table, another chunk can be processed. Otherwise, the further processing is rejected due to a modification of the DCF object.

Even though a calculation of the control values by means of hash algorithms was described in the preceding description, it is obvious that the approach according to invention is not limited to hash functions, but that control values or checksums of any kind can be formed. For example, a parity calculation can be performed. Furthermore, the approach of the invention can be used for all applications in which a checking of the integrity of data is necessary. As regards such applications, they can be e.g. computer systems or digital message transmission systems. In computer systems, e.g. the control values can be generated when storing the data, and stored together with same. At a subsequent retrieval and use of the data, the control values can also be retrieved and used for checking the data. In transmission systems, the control values can be calculated directly before a transmission of the data and then be transmitted together with the data and evaluated in the receiver. In this way, it can be guaranteed that the data have been transmitted correctly.

For checking per section the integrity of digital information, the data are subdivided into partial sets. The partial sets can be independent from each other or overlap. In particular, the partial sets can be independently decodable or syntactically analyzable. The device for checking a data set can be part of an encoder and the device for determining a control value can be part of a decoder.

Depending on the circumstances, the method for checking a data set according to the invention as well as the method for determining a control value according to the invention can be implemented in hardware or in software. The implementation can occur on a digital storage medium, in particular a disk or CD with electronically readable control signals, which can cooperate with a programmable computer system so that the corresponding method can be performed. Generally, the invention thus also consists in a computer program product with a program code stored on a machine-readable carrier for performing the method according to the invention when the computer program product is executed on a computer. In other words, the invention can thus be implemented as a computer program with a program code for performing the method when the computer program is executed on a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A device for checking a data set, the data set having a plurality of partial sets and a partial control value per partial set, comprising:
a determiner for determining a control value, which is formed so as to determine a common control value from the provided partial control values of the partial sets of the data set;
a comparer, which is formed so as to compare the common control value to a comparison control value provided to the comparer;
wherein the determiner is formed, furthermore, so as to determine a further partial control value for one of the partial sets of the data set; and
wherein the comparer is formed, furthermore, so as to compare, for checking the partial set, the further partial control value to the provided partial control value of the corresponding partial set and to provide a check result as a function of the comparison; and
a user for using the data set, which is formed so as to use the data of one of the partial sets in parallel to the checking of the partial set, and is formed, furthermore, so as to interrupt a use of the data set as a consequence of the check result, when the check result indicates a mismatch.

2. The device for checking according to claim 1, wherein the comparer is formed so as to provide a comparison signal as a function of the comparison of the common control value to the comparison control value, and
wherein the determiner is formed, furthermore, so as to determine the further partial control value as a function of the comparison signal.

3. The device for checking according to claim 1, wherein the user is formed so as to use the partial set as a consequence of the check result, when the check result indicates a match.

4. The device for checking according to claim 1, wherein the data set has furthermore a plurality of intermediate control values, each of the intermediate control values being formed from a plurality of partial control values, and
wherein the determiner is formed, furthermore, so as to determine the common control value from the plurality of the provided intermediate control values and is formed, furthermore, so as to determine, as a function of the comparison of the common control value to the provided control value, a plurality of further intermediate control values from the plurality of partial control values.

5. The device for checking according to claim 4, wherein the comparer is formed, furthermore, so as to compare the further intermediate control values to the provided intermediate control values.

6. The device for checking according to claim 1, wherein the control values are hash values, and wherein the determiner is formed so as to determine the hash values using a predetermined hash algorithm.

7. A method for checking a data set, wherein the data set has a plurality of partial sets and a partial control value per partial set, comprising:
determining a common control value from the provided partial control values of the partial sets;
comparing the common control value to a provided comparison control value;
determining a further partial control value for one of the partial sets of the data set;
comparing the further partial control value to the provided partial control value of the corresponding partial set for checking the partial set and providing a check result as a function of the comparison;
using the data of one of the partial sets in parallel to the checking of the partial set; and
interrupting a use of the partial set as a consequence of the check result, when the check result indicates a mismatch.

8. A computer program with a program code for performing the method for checking a data set, wherein the data set has a plurality of partial sets and a partial control value per partial set, the method comprising:
determining a common control value from the provided partial control values of the partial sets;
comparing the common control value to a provided comparison control value;
determining a further partial control value for one of the partial sets of the data set;
comparing the further partial control value to the provided partial control value of the corresponding partial set for checking the partial set and providing a check result as a function of the comparison;
using the data of one of the partial sets in parallel to the checking of the partial set; and
interrupting a use of the partial set as a consequence of the check result, when the check result indicates a mismatch;
when the computer program is executed on a computer.
